(19) United States
(12) Patent Application Publication
(10) Pub. No.: US 2012/0062735 A1
(43) Pub. Date: Mar. 15, 2012

(54) CRIB MONITORING SYSTEM

(76) Inventor: Eric Rivera, Medford, NY (US)

(21) Appl. No.: 13/082,972

(22) Filed: Apr. 8, 2011

Related U.S. Application Data
(60) Provisional application No. 61/322,273, filed on Apr. 8, 2010.

(51) Int. Cl. H04N 7/18

(52) U.S. Cl. 348/143; 348/E07.085

(57) ABSTRACT

A crib monitoring system for a crib having a plurality of crib posts disposed a predetermined distance apart, and a side gate including a plurality of bar portions disposed between and connectable to the crib posts. The crib monitoring system includes at least one camera device connected to a crib post of the plurality of crib posts and configured to capture an image of an interior of the crib, a plurality of sensor devices, each sensor device connected with a respective crib post, and configured to form a signal beam along an interior surface of the side gate between the crib posts, and a monitoring device configured to receive a warning signal when a baby within the crib is within a predetermined distance of the bar portions such that the signal beam is interrupted.

### CROSS-REFERENCE

The present invention claims priority to Provisional Application Ser. No. 61,322,273 filed Apr. 8, 2010, entitled “Crib. Monitoring System”, which is hereby incorporated by reference.

### BACKGROUND

The present invention relates to a crib monitoring system, and more specifically, to an improved crib monitoring system that warns a user when a baby within a crib is too close to side bars of the crib.

Conventionally, crib monitoring systems provide audio and/or video feeds to allow users (e.g., parents) to observe what is happening in a baby's crib. However, there are several problems associated with the conventional crib monitoring systems. These crib monitoring systems fail to provide an alarm or other warning when a baby comes within close proximity to a side of the crib. If the baby gets caught in the side bars of the crib but does not cry, the user may not realize that the baby is in danger, thereby resulting in injuries to the baby.

Therefore, it is desirable to have a crib monitoring system that includes a warning mechanism to allow a user to receive a warning to thereby prevent the occurrence of injuries to babies.

### SUMMARY

The present invention obviates the above-mentioned problem, by providing a crib monitoring system for a crib that allows a user to receive a warning when a baby therein is within close proximity to the side bars of the crib and in danger of being injured.

According to one embodiment of the present invention, a crib monitoring system for a crib having a plurality of crib posts disposed a predetermined distance apart, and a side gate including a plurality of bar portions disposed between and connectable to the crib posts. The crib monitoring system includes at least one camera device connected to a crib post of the plurality of crib posts and configured to capture an image of an interior of the crib, a plurality of sensor devices, each sensor device connected with a respective crib post, and configured to form a signal beam along an interior surface of the side gate between the crib posts, and a monitoring device configured to receive a warning signal when a baby within the crib is within a predetermined distance of the bar portions such that the signal beam is interrupted.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a diagram illustrating a crib monitoring system for a crib that can be implemented within embodiments of the present invention.

FIG. 2 is an exploded view of an embedded camera device within the crib monitoring system shown in FIG. 1 that can be implemented within embodiments of the present invention.

FIG. 3 is an exploded view of an embedded sensor device within the crib monitoring system shown in FIG. 1 that can be implemented within embodiments of the present invention.

FIG. 4 is a diagram illustrating a monitoring device of the monitoring system that can be implemented within embodiments of the present invention.

FIG. 5 is a block diagram illustrating various components of the monitoring device shown in FIG. 4 that can be implemented within embodiments of the present invention.

FIG. 6 is a flow chart illustrating an operation of the crib monitoring system of FIG. 1 that can be implemented within embodiments of the present invention.

### DETAILED DESCRIPTION

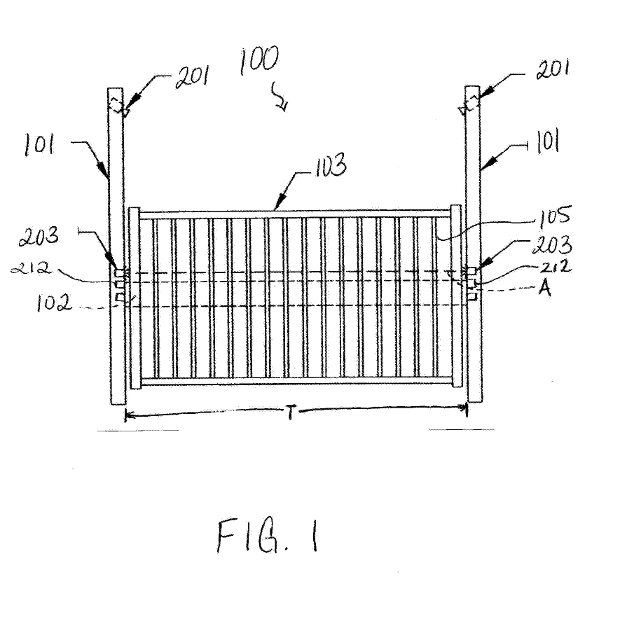

Now referring to FIG. 1, a crib monitoring system for a crib that can be implemented within embodiments of the present invention is provided. A crib 100 is provided. The crib 100 includes a plurality of crib posts 101 disposed a predetermined distance apart, a mattress assembly 102, and a side gate 103 including a plurality of bar portions 105 disposed between and connectable to the crib posts 101. A crib monitoring device 200 is provided. The crib monitoring device 200 includes at least one camera device 201 connected to a crib post 101 of the plurality of crib posts 101 and configured to capture an image (e.g., a still and/or video image) of an interior of the crib 100. Embodiment of the present invention are directed to capturing video image however the present invention is not limited hereto and still images may be captured. The crib monitoring device 200 further includes a plurality of sensor devices 203. According to an embodiment of the present invention, each sensor device 203 is connected with a respective crib post 101, and configured to form a signal beam (as indicated by the dashed line ‘A’) in a horizontal direction along an interior surface of the side gate 103 between the crib posts 101. According to an embodiment of the present invention, the crib monitoring system 200 may be manufactured with a crib as a “single” unit. The camera devices 201 and the sensor devices 203 may be secured within respective housings of the crib posts 101 via screws or any type of suitable connecting means.

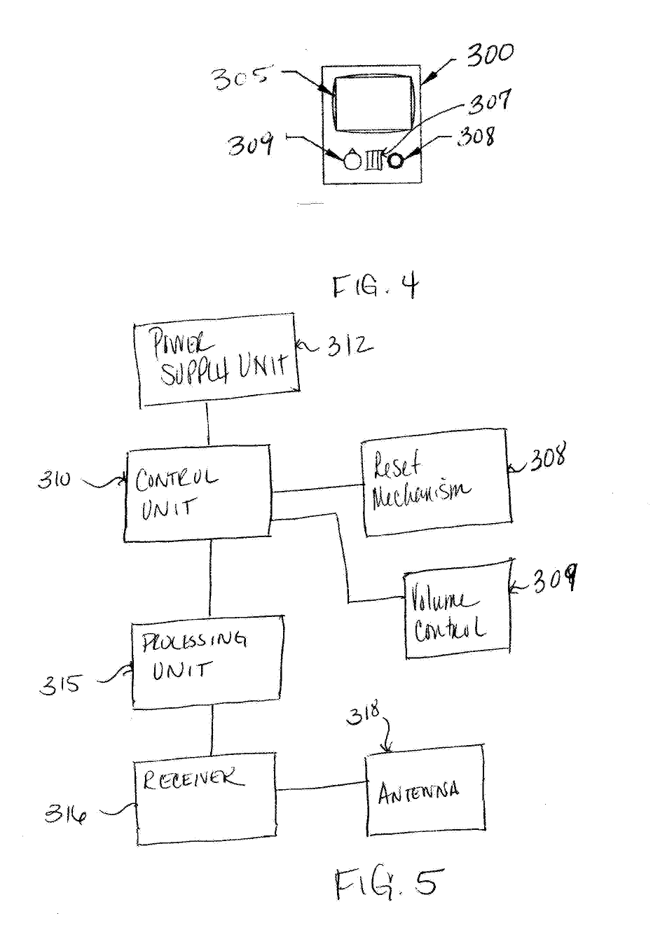

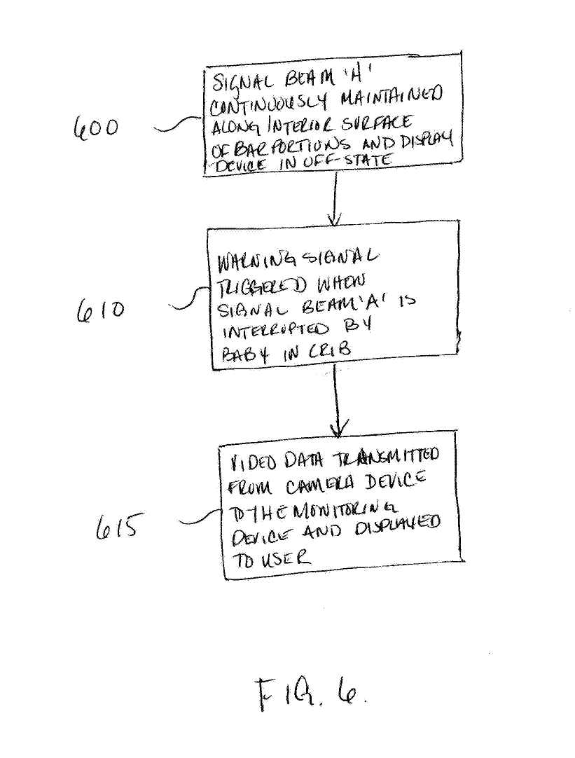

According to an embodiment of the present invention, the sensor devices 203 may be laser devices, or any other suitable sensor device capable of monitoring movement a predetermined distance from the side gate 103. The crib monitoring system 200 further includes a monitoring device 300 configured to receive a warning signal when a baby within the crib 100 is within a predetermined distance of the bar portions 105 such that the signal beam ‘A’ is broken. Additional details regarding the monitoring device 300 will be discussed below with reference to FIGS. 4 and 5.

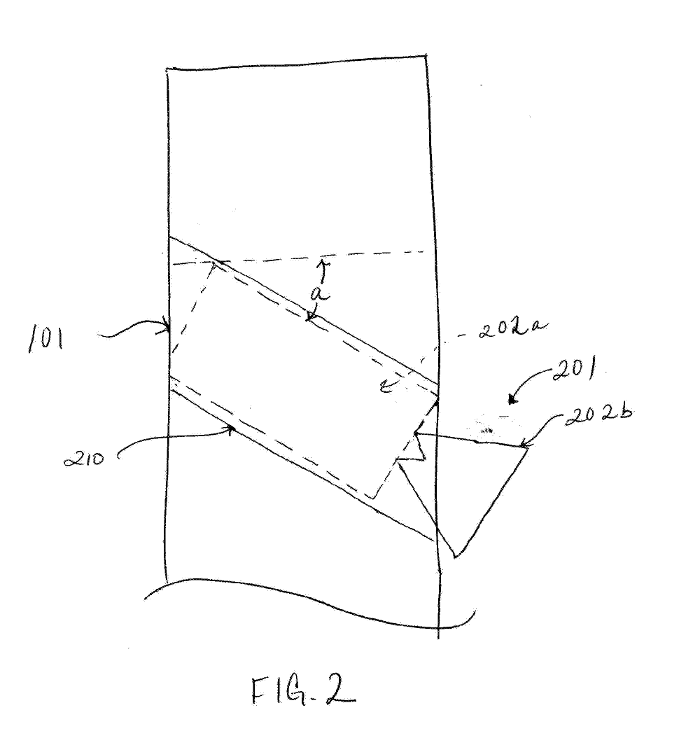

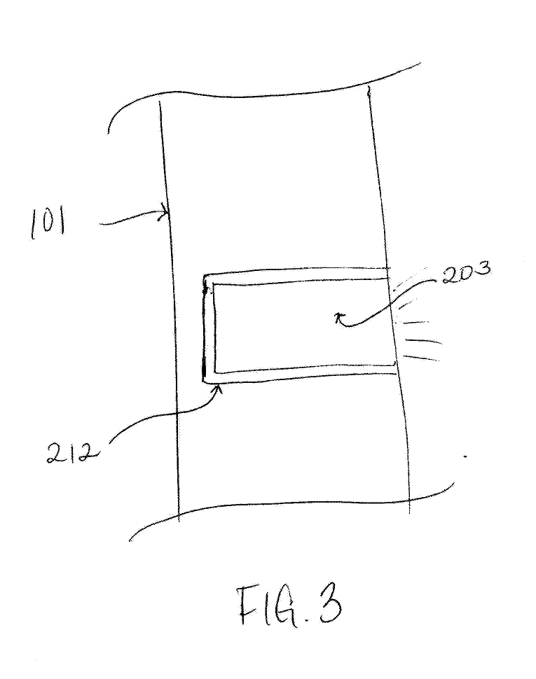

According to an embodiment of the present invention, the camera devices 201 and the sensor devices 203 may be integrally combined within the crib such that they are embedded within the crib posts 101 as shown in FIG. 1. Detailed concerning the position of the camera devices 201 and the sensor devices 203 will now be discussed below with reference to FIGS. 2 and 3.

FIG. 2 is an exploded view of an embedded camera device within the crib monitoring system shown in FIG. 1 that can be implemented within embodiments of the present invention. As shown in FIG. 2, the crib 100 further includes at least one first housing portion 210 for receiving the at least one camera device 201 therein. The camera device 201 is embedded within the crib post 101 at an angled position to capture the image of the interior of the crib 100. According to an embodiment of the present invention, the camera device 201 may be positioned at an angle α ranging between 10 to 30 degrees. That is, a body portion 202a of the camera device 201 may be positioned at angle α. In addition, a lens portion 202b of the camera device 201 is also adjustable to an angle as desired by a user. The camera device 201 and the housing 210 are a predetermined distance from a top surface of the crib post 101. The predetermined distance may range from approximately 3 to 15 inches for example. However, the present invention is not limited hereto. According to an embodiment of the present invention, the camera device 201 may be any type of camera device such as a digital video camera, capable of capturing still and video images. The camera device 201 has night vision capabilities to be able to see the baby when it is dark in the room. The camera device 201 is also capable of communicating with the sensor devices 203 and transmitting image data (e.g., video feed) and signal data directly to the monitoring device 300 (depicted in FIG. 4), upon receiving a warning signal from at least one of the sensor devices 203. The camera device 201 may have a transmitter and receiver integrally combined therein to facilitate the transmission of data to the monitoring device 300. The camera device 201 further includes angle and zoom adjustment capabilities, for example. The camera device 201 includes a body portion 202a and a lens portion 202b. The angle of the lens portion 202b is able to be adjusted as desired by the user. The present invention is not limited to any particular type or number of camera devices 201, and may vary accordingly. As shown in FIG. 1, a pair of camera devices 201 is provided. In this embodiment, each camera device 201 is embedded within a respective crib post 101 at an angled position to capture an image of the interior of the crib 100. Additional details regarding the sensor devices 203 will now be discussed below with reference to FIG. 3.

FIG. 3 is an exploded view of an embedded sensor device within the crib monitoring system shown in FIG. 1 that can be implemented within embodiments of the present invention. As shown in FIG. 3, each crib post 101 includes a plurality of second housing portions 212 to receive and house the sensor devices 203. This allows the position of each sensor device 203 to be adjusted as desired by the user, upon adjusting the mattress assembly 102 position. The sensor devices 203 may be positioned at a location at or above a level of the mattress assembly 102. Thus, each sensor device 203 may be embedded within the respective crib post 101. According to an embodiment of the present invention, the sensor devices 203 may be a line of sight laser device or any other sensor device suitable for sensing movement at the interior surface of the bar portions 105 of the side gate 103. An operation and communication of the sensor devices 203 and camera devices 201 will be discussed below with reference to FIG. 6.

According to an embodiment of the present invention, the camera devices 201 and the sensor devices 203 may be battery-operated or solar-powered or may receive power via a conventional outlet or any other suitable power source.

The present invention provides a means for remotely observing any movement activity within the interior of the crib 100 and remotely receiving a warning signal when a baby therein may be in danger of being injured. According to another embodiment of the present invention, the crib monitoring system 200 may also function as a typical crib monitoring device in addition to that of the functions described herein. That is, a user may be able to listen to the baby within the crib via the monitoring device 300, when desired. In this case, a speaker (not shown) would be provided at the crib 100. Details regarding the monitoring device 300 of the present invention will now be described below with reference to FIG. 4.

FIG. 4 is a diagram illustrating a monitoring device of the monitoring system that can be implemented within embodiments of the present invention: As shown in FIG. 4, the monitoring device 300 is provided and includes a display device 305 configured to receive and display the image captured by the camera device(s) 201 and a speaker 307 configured to broadcast the warning signal when the baby is within a predetermined distance of the bar portions 105 such that the signal beam generated by the sensor devices 203 is broken. According to an embodiment of the present invention, the sensor devices 203 are of a predetermined distance of between approximately ½ inch to 2 inches from the bar portions 105 however the present invention is not limited hereto and the range may vary as needed.

According to an embodiment of the present invention, the monitoring device 300 may be a portable handheld device. Alternatively, the functions of the monitoring device 300

According to an embodiment of the present invention, the monitoring device 300 further includes a reset mechanism 308 to reset the crib monitoring system 200 when desired by a use and a volume control mechanism 309 may also be provided to control the volume setting of the monitoring device 300. Additional details concerning components of the monitoring device 300 will now be discussed below with reference to FIG. 5.

FIG. 5 is a block diagram illustrating various components of the monitoring device shown in FIG. 4 that can be implemented within embodiments of the present invention. As shown in FIG. 5, the display device 305, speaker 307, reset mechanism 308 (e.g., a switching device), and the volume control mechanism 308 are provided. In addition, a control unit 310 configured to control monitoring device 300 and a power supply unit 312 configured to supply power to the monitoring device are also provided. A processing unit 315 is provided and configured to receive and process the video feed and warning signal data received from the camera devices 201 and the sensor devices 203 at the crib 100 via a receiver 316 in communication with an antenna 318 at the monitoring device 300. An operation of the crib monitoring system 200 will now be described below with reference to FIG. 6.

FIG. 6 is a flow chart illustrating an operation of the crib monitoring system of FIG. 1 that can be implemented within embodiments of the present invention. As shown in FIG. 6, at operation 600, during normal operation, a signal beam ‘A’ (as depicted by a dashed line) is continuously maintained along the interior surface of the bar portions 105 along a length ‘T’ of the crib. According to an embodiment of the present invention, the length ‘T’ is the distance from one crib post 101 to another crib post 101 at the opposite end of the crib 100. According to an embodiment, at operation 600, the display device 305 (as depicted in FIG. 5) may remain in an off-state until a warning signal is received at the monitoring device 300. According to another embodiment, the display device 305 may be activated by a user at any time to view the interior of the crib 100. From operation 600, when the baby within the crib 100 moves too close (i.e., within a predetermined distance such as approximately ½ to 1 inch) to the bar portions 105 such that the signal beam ‘A’ is interrupted, triggering a warning signal to be sent to the processing unit 315 of the monitoring device 300 at operation 610. The warning signal may be sent directly from the sensor device 203 to the processing unit 315 and to the camera device 201 to activate the transmission of video data to the processing unit 315. According to an embodiment of the present invention, the warning signal may be sent simultaneously from the sensor device 203 to the processing unit 315 and the camera device 201. Alternatively, the warning signal may be transmitted from the sensor device 203 to the camera device 201 and then the warning signal and the video data together are transmitted to the processing unit 315 from the camera device 201. According to yet another embodiment, the warning signal may be transmitted from the sensor device 203 to the processing unit 315 prior to activating and transmitting the video data from the camera device 201. From operation 610, the process continues to operation 615, where video feed is activated such that video data is transmitted wirelessly via the camera device 201 to the monitoring device 300, and a video image is displayed via the display device 305 at the monitoring device 300, thereby allowing the user to view the baby within the crib 100 and determine whether the baby is in any danger. According to an embodiment of the present invention, an audible warning may be broadcast via the speaker 307 at the monitoring device 300. Alternatively, in addition to the audible warning, a warning light may also be provided at the monitoring device 300 via a light emitting diode (LED) flashing to indicate a warning signal.

According to embodiments of the present invention, a crib monitoring system is provided having camera devices and sensor devices for producing video images and a warning signal at a monitoring device. Therefore, an advantage of the present invention is to enable a user to determine whether a baby within the crib is in danger of being injured.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when, used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A crib monitoring system for a crib including a plurality of crib posts disposed a predetermined distance apart, and a side gate including a plurality of bar portions disposed between and connectable to the crib posts, the crib monitoring system comprising:
at least one camera device connected to a crib post of the plurality of crib posts and configured to capture an image of an interior of the crib;
a plurality of sensor devices, each sensor device connected with a respective crib post, and configured to form a signal beam along an interior surface of the side gate between the crib posts; and
a monitoring device configured to receive a warning signal when a baby within the crib is within a predetermined distance of the bar portions such that the signal beam is interrupted.

2. The crib monitoring system of claim 1, wherein the at least one camera device is embedded within a crib post at an angled position to capture the image of the interior of the crib.

3. The crib monitoring system of claim 2, wherein the at least one camera includes a pair of camera devices, each camera device embedded within a respective crib post at an angled position to capture an image of the interior of the crib.

4. The crib monitoring system of claim 1, wherein each sensor device is embedded within the respective crib post.

5. The crib monitoring system of claim 1, wherein monitoring device comprises:
a display device configured to receive and display the image captured by the at least one camera device;
a speaker configured to broadcast the warning signal;
reset mechanism to reset the crib monitoring system when desired by a user;
a control unit configured to control the display device and a volume setting of the speaker; and
a power supply unit configured to supply power to the monitoring device.

6. The crib monitoring system of claim 5, wherein the monitoring device further comprises:
a receiver;
an antenna; and
a processing unit configured to receive and process video data associated with the image, and warning signal data associated with the warning signal as received from the at least one camera device and the sensor devices via the receiver in communication with the antenna at the monitoring device.

7. The crib monitoring system of claim 1, wherein during normal operation, the signal beam is continuously maintained along the interior surface of the bar portions along length of the crib from one crib post to another crib post at an opposite end of the crib.

8. The crib monitoring system of claim 5, wherein:
during the normal operation, the display device remains in an off-state until the warning signal is received at the monitoring device, and
upon receiving the warning signal, an image is displayed via the display device at the monitoring device.

9. The crib monitoring system of claim 5, wherein the monitoring device is a portable handheld device.

10. The crib monitoring system of claim 1, wherein the at least one camera device and the sensor devices are battery-operated or solar-powered.

11. The crib monitoring system of claim 1, wherein the predetermined distance ranges from between approximately ½ inch to approximately 1 inch.

11. The crib monitoring system of claim 1, wherein the crib comprises:
at least one first housing portion for receiving the at least one camera device therein; and
second housing portions to each receive a sensor device of the plurality of sensor devices therein.

12. The crib monitoring system of claim 6, wherein the warning signal is sent directly from at least one of the sensor devices to the processing unit and to the camera device to activate the transmission of video data to the processing unit.

13. The crib monitoring system of claim 12, wherein the warning signal is sent simultaneously from the sensor device to the processing unit and the camera device.

14. The crib monitoring system of claim 6, wherein the warning signal is transmitted from the at least one sensor device to the at least one camera device and then transmitted the warning signal and the video data together to the processing unit from the at least one camera device.

15. A method of operating a crib monitoring system including a plurality of sensor devices and at least one camera device housed within a crib and portable monitoring device remotely positioned, the method comprises:
continuously maintaining, via the sensor devices, a signal beam along an interior surface of bar portions of the crib;
generating a warning signal via at least one of the sensor devices when the signal beam is interrupted by movement of a baby within the crib; and
transmitting video data from the at least one camera device to the monitoring device when the warning signal has been generated; and
displaying via a display device at the monitoring device, an image associated with the video data.

16. The method of claim 15, wherein generating a warning signal further comprises:
transmitting the warning signal generated, directly from the at least one sensor device to the monitoring device and the camera device to active transmission of the video data to the monitoring device.

17. The method of claim 16, wherein generating a warning signal further comprises:
transmitting the warning signal generated, simultaneously to the monitoring device and the camera device

18. The method of claim 15, wherein generating a warning signal further comprises:
transmitting the warning signal from the at least one sensor device to the at least one camera device and then transmitting the warning signal and the video data together to the monitoring device from the at least one camera device.

19. The method of claim 15, wherein during normal operation, the display device at the monitoring device remains in an off-state until the warning signal is received at the monitoring device, and upon receiving the warning signal, the image is displayed via the display device.
